(19) United States
(12) Patent Application Publication
(10) Pub. No.: US 2025/0150761 A1
(43) Pub. Date: May 8, 2025

(54) LOUDSPEAKER WITH ROLLING SUSPENSION DEVICE

(71) Applicant: POWERSOFT S.P.A, SCANDICCI (IT)

(72) Inventor: CLAUDIO LASTRUCCI, LASTRA A SIGNA FIRENZE (IT)

(21) Appl. No.: 18/932,717

(22) Filed: Oct. 31, 2024

(30) Foreign Application Priority Data
Nov. 3, 2023 (IT) 102023000023184

(51) Int. Cl. H04R 9/06

(52) U.S. Cl. CPC H04R 9/06

(57) ABSTRACT

Described is a loudspeaker (10) comprising: a radiator (1), movable along a longitudinal axis (X) for generating pressure waves; a basket (2), surrounding the radiator (1), so as to form a liner (C) between the radiator (1) and the basket (2), the liner (C) being delimited by an inside surface (201) of the basket (2) and an outside surface (101) of the radiator (1); a magnetic circuit (3), defining a path for the circulation of a magnetic field and including a stationary magnetic element (301), connected to the basket (2), and a movable magnetic element (302), connected to the radiator (1) and movable under the action of the magnetic field for moving the radiator (1) in response to an electrical signal to be transduced; a ring (4) made of elastomeric material, coaxial with the longitudinal axis (X) and positioned inside the liner (C), in contact with the outside surface (101) of the radiator (1) and the inside surface (201) of the basket (2) so as to roll on them, moving longitudinally in response to a relative movement between the radiator (1) and the basket (2).

This invention relates to a loudspeaker and a method for spreading a sound.

Generally, the loudspeakers comprise an electromechanical transduction system, for converting a variable electrical signal into a mechanical movement of a radiator, so as to generate an acoustic wave. These transduction systems comprise a magnetic element integral with the fixed parts of the acoustic diffuser and a movable magnetic element, connected to the radiator, for moving it; in particular, the movable magnetic element-a coil or a magnet-moves under the action of the magnetic field generated by the integral magnetic element.

In this context, there are two types of electromechanical transduction systems. According to the most widespread system, the so-called “movable coil”, the integral magnetic element is a permanent magnet, whilst the movable magnetic element is a coil; the coil is energised by the electrical signal to be transduced and this moves in response to the interaction with the magnetic field generated by the permanent magnet. An example of a movable coil system is described in patent document U.S. Pat. No. 5,014,323A. Alternatively, according to a system known as “movable magnet”, the integral magnetic element consists of a fixed coil, whilst the movable magnetic element is a magnet; the fixed coil is energised by the electrical signal and the movable magnet moves in response to the magnetic field generated by the coil. An example of a movable magnet system is described in patent document EP2550724, in the name of the same Applicant.

Generally, the loudspeakers comprise a suspension device, connected between the radiator and the basket, to allow a relative movement between them. The suspension devices, however, limit the travel of the movement between the radiator and the basket and are subject to frequent breakages. In order to increase the travel, it is possible to use larger suspension devices, however, in this way the overall dimensions of the loudspeaker are increased.

Patent document GB348425A describes a loudspeaker including a suspension device made by means of a tube, placed between the basket and the radiator; however, even this document cannot meet the needs of the market.

Patent document EP4207809A1, by the same Applicant, describes a loudspeaker including a guiding device made of a tube; however, this guiding device can not be used in a suspension device.

The aim of this invention is to provide a loudspeaker and a method for spreading a sound which overcome the above-mentioned drawbacks of the prior art.

Said aims are fully achieved by the loudspeaker and by the method for spreading a sound according to the invention, as characterised in the appended claims.

In particular, the loudspeaker comprises a radiator. The radiator is movable along a longitudinal axis for generating pressure waves.

The loudspeaker comprises a basket. The basket surrounds the radiator (about the longitudinal axis), so as to form a liner or hollow space between the radiator and the basket. In particular, the liner is delimited by an inside surface of the basket and an outside surface of the radiator. In other words, the basket has an inside surface, that is to say, a surface facing towards the longitudinal axis, and the radiator has an outside surface facing in the opposite direction relative to the longitudinal axis; the inside surface and the outside surface act in conjunction to delimit a liner. The liner surrounds the longitudinal axis.

Preferably, the liner extends substantially parallel to the longitudinal axis. However, the liner could extend about the longitudinal axis according to other orientations, for example the liner could extend in a conical shape along the longitudinal axis. In particular, the inside surface of the basket develops (substantially) parallel to the longitudinal axis, and the outer surface of the radiator develops (substantially) parallel to the longitudinal axis.

The radiator has a perimeter edge. The perimeter edge develops around the longitudinal axis. In an embodiment, the outside surface of the radiator projects from the perimeter edge of the radiator toward an interior of the loudspeaker. Specifically, the outside surface of the radiator projects from the perimeter edge of the radiator toward an interior of the liner.

Preferably, the inner wall of the basket and the outside surface of the radiator have essentially the same development around the longitudinal axis. In particular, the inside surface of the basket and the outside surface of the radiator develop around the longitudinal axis so as to define between them a uniform liner around the longitudinal axis.

Preferably, the inside surface of the basket and the outside surface of the radiator have substantially the same development along the longitudinal axis. In particular, the inside surface of the basket and the outside surface of the radiator develop parallel to the longitudinal axis and present (substantially) the same height along the longitudinal axis. Preferably, the inside surface of the basket has a main direction of development parallel to the longitudinal axis, and the outside surface of the radiator has a main direction of development parallel to the longitudinal axis.

In one example, the liner may develop along a development axis parallel to the longitudinal axis. The liner develops along the development axis between an upper opening and a lower opening, opposite to the upper opening. So, the inside surface of the basket and the ouside surface of the radiator develop parallel to the development axis of the liner.

In particular, the upper opening is proximal to the perimeter edge of the radiator. The upper opening and the lower opening are aligned along the liner development axis.

In an embodiment form, the liner is open to the environment outside the loudspeaker. Specifically, the liner is open to the external environment through the upper opening. So, the upper opening connects the liner with the environment outside the speaker.

In other words, the liner is open to the environment outside the speaker at the perimeter edge. The jacket is open to an environment inside the speaker via the lower opening. So, the bottom opening connects the liner with the environment inside the speaker.

The liner results open to the environment outside the speaker. In this way, the radiator has the ability to move freely with respect to the longitudinal axis, allowing a greater excursion. The loudspeaker comprises a magnetic circuit. Generally, the magnetic circuit is configured to generate a magnetic field and defines a path for the circulation of a magnetic field.

In particular, the magnetic circuit defines a path for the circulation of a magnetic field. The magnetic circuit includes a stationary magnetic element. The stationary magnetic element is connected to the basket. The magnetic circuit includes a movable magnetic element, connected to the radiator. The movable magnetic element is movable under the action of the magnetic field, to move the radiator in response to an electrical signal to be transduced. The movable magnetic element may include a movable magnet or a movable coil. The stationary magnetic element may include a stationary coil and/or one or more stationary magnets. The magnetic circuit may define a transducer.

According to an example, the movable magnetic element includes a movable coil and the stationary magnetic element includes one or more fixed magnets; the movable coil is configured to receive an electric signal to be transduced and generate a magnetic field in response to the electric signal; the one or more fixed magnets are configured to generate a constant magnetic field; the magnetic field generated by the coil and the constant magnetic field generated by the one or more fixed magnets act in conjunction to generate a total magnetic field to move the movable coil.

According to an example, the movable magnetic element includes one or more movable magnets and the fixed magnetic element includes a fixed coil; the fixed coil is configured to receive an electrical signal to be transduced and generate a magnetic field in response to the electrical signal; the one or more movable magnets are configured to move under the action of the magnetic field generated.

The loudspeaker includes a ring. Generally speaking, the ring is made of deformable material. In particular, the ring is made of plastic material; more specifically, elastomeric material. The ring is coaxial with the longitudinal axis and positioned inside the liner. The ring is in contact with the outside surface of the radiator and the inside surface of the basket so as to roll on them. In particular, the ring moves in response to a relative movement between the radiator and the basket. Preferably, the ring moves longitudinally in response to a relative movement between the radiator and the basket. The aim of the ring is to guide the movement of the radiator relative to the basket and to centre the radiator relative to the longitudinal axis.

The ring, being made of plastic (or elastomeric) material, is deformable inside the liner and therefore constitutes a rolling pneumatic seal system. The ring may advantageously be used instead of a classic suspension device located between the radiator and the basket at the perimeter edge (outline or edge) of the radiator.

Under equal conditions of radial dimensions of the loudspeaker, with respect to the suspension device, the ring allows a greater travel of the movement between the radiator and the basket; in effect, in order to allow a greater travel between radiator and basket, it is necessary to use a radially larger suspension device, and it is therefore necessary to reduce the size of the radiator; however, this factor considerably reduces the general performance of the loudspeaker.

Moreover, since the ring has a reduced radial size, the mass, and therefore the total inertia of the system, is contained, thus allowing greater accelerations and thus better performance levels to be obtained.

Moreover, the use of the ring is particularly advantageous in making non-axially symmetric loudspeakers, for example square radiant pistons, for example with rounded corners and in general more complex shapes which can be difficult to make with a classic suspension device.

The ring is also easy to install between the radiator and the basket, since, unlike a suspension device, it does not require the use of adhesives during assembly and therefore considerably simplifies assembly and any replacements. Moreover, the cost of the ring is relatively low and it can be made using standard production methods such as those used for the production of the O-rings.

According to an embodiment, the radiator comprises a flange. The flange extends along the longitudinal axis between a first end and a second end opposite the first end. The flange defines the outside surface of the radiator. Preferably, the flange extends parallel to the longitudinal axis. However, the flange may extend according to different orientations relative to the longitudinal axis, for example transversely to the longitudinal axis. The flange surrounds the longitudinal axis. The radiator may have a conical shape (thus, the radiator may be a cone), or cylindrical (so the radiator may be a piston).

In one example, the flange results connected to the perimeter edge of the radiator. The flange develops from the first end to the second end toward an interior of the speaker. So, the flange develops from the second end to the first end toward an exterior of the speaker. In other words, the first end results proximal to the environment outside the loudspeaker and the second end results distal to the environment outside the loudspeaker. In particular, at the first end, the flange is in communication with the environment outside the speaker. The first end defines (at least partially) the upper opening of the liner.

In an embodiment form, the loudspeaker includes a main portion (or membrane). The main portion can have a conical shape (i.e., the main portion can be tapered toward the longitudinal axis) or a planar shape (i.e., the main portion can develop in a plane perpendicular to the longitudinal axis). Specifically, the conical shape of the membrane defines a radiator of the cone type, while the planar shape of the membrane defines a radiator of the piston type.

In particular, the main portion (membrane) defines a perimeter edge (i.e., the perimeter edge of the radiator). More specifically, main portion (membrane) results connected to the flange of the radiator, preferably at the perimeter edge of the main portion and at the first end of the flange. Generally, the main portion and flange have different development around the longitudinal axis (i.e. different inclinations to the longitudinal axis). In particular, the flange develops parallel to the longitudinal axis, while the main portion develops along a direction transverse to the longitudinal axis (in the case of planar development, the direction is perpendicular to the longitudinal axis).

In an embodiment form, an angle between the main portion and the flange of the radiator is equal to or less than 90 degrees. Preferably, in the case where the main portion has a planar development, the main portion and the flange form an angle equal to 90 degrees; in the case where the main portion has a conical development, the main portion and the flange form an angle less than 90 degrees. It is observed that this angle is evaluated between an inner surface (opposite to the outer surface) of the radiator and the main portion of the radiator.

The fact that the flange develops from the first end toward an interior of the speaker (or more specifically, the fact that an angle formed between the main portion and the flange is equal to or less than 90 degrees), ensures compactness of the speaker itself.

In an embodiment form, the basket has a main portion developing longitudinally (parallel to the longitudinal axis). Preferably, such longitudinally developing main portion defines the inner surface of the basket (in turn delimiting the liner). The basket may have a secondary portion developing parallel to the longitudinal axis. The main portion and the secondary portion are reciprocally connected. In particular, the secondary portion is at substantially the same height as the perimeter edge of the radiator (in particular, as the perimeter edge of the main portion of the radiator). At the secondary portion of the basket, the basket may have mounting holes for attaching the loudspeaker (to a support external to the loudspeaker). In the case where the main portion of the radiator has a planar development, the main portion of the radiator and the secondary portion of the basket are developed along the same plane; in particular, the main portion of the radiator and the secondary portion of the basket are at the same height along the longitudinal axis.

According to an example, the loudspeaker comprises a perimeter edge (that is the perimetral edge), positioned on a plane transversal to the longitudinal axis, preferably at the first end of the flange. The perimeter edge projects towards the inside of the liner. The perimeter edge may be provided in the radiator and/or in the basket. Preferably, at the first end of the flange (that is, at the perimeter edge), the radiator and the basket are separated from each other by a volume of air open on the outside environment.

The radiator may comprise an outline; the outline may extend about the longitudinal axis in such a way as to have a shape which is circular (uniform or elongate along an axis), square, rectangular (with or without rounded corners) and so on. The flange may be located at the outline of the radiator. The flange extends along the longitudinal axis corresponding to the shape of the outline of the radiator.

According to an example, at the first end of the flange, the radiator and the basket are separated from each other by a volume of air open on the outside environment. The ring therefore separates the liner into a first space, that is, a volume of air open on the outside environment, and into a second space, that is, a volume of air isolated from the outside environment.

According to an example, the outline of the radiator defines the perimeter edge of the amplifier. According to an embodiment, the perimeter edge projects from the flange towards the inside of the liner, at the first end of the flange. The perimeter edge is separated from the basket by a volume of air open on the outside environment.

According to an example, the basket comprises a perimeter edge, positioned on a plane transversal to the longitudinal axis. The perimeter edge may be projecting towards the inside of the liner, at the first end of the flange (or at the perimeter edge of the radiator). The perimeter edge of the basket is separated from the radiator (in particular from the first end of the flange or from the perimeter edge of the radiator) by a volume of air open on the outside environment.

According to an embodiment, the loudspeaker comprises a further perimeter edge. The further perimeter edge is positioned on a further plane transversal to the longitudinal axis. Preferably, the further perimeter edge is positioned at the second end of the flange, or it may be positioned at a point between the first end and the second end (for example in the mid-point). The further perimeter edge may be provided in the flange of the radiator or on the inside surface of the basket. The further perimeter edge projects towards the inside of the liner. The ring is configured to roll, preferably along the longitudinal axis, between the perimeter edge and the further perimeter edge. For this reason, the perimeter edge and the further perimeter edge constitute, respectively, a starting point and an end point for the ring.

The liner has a width, that is to say, a radial width. The width is defined in a direction radial to the longitudinal axis. The radial width is between the inside surface of the basket and the outside surface of the radiator. The radial width extends along the longitudinal axis so as to reduce towards the first end (that is, the perimeter edge) and the second end (that is, the further perimeter edge) of the flange. In other words, the (radial) width of the liner is greater at a rest point between the first and the second end of the flange (that is, between the perimeter edge and the further perimeter edge) and is less at the first end and the second end (that is, of the perimeter edge and the further perimeter edge).

In this way, the ring is recalled towards a point (a rest point) between the first and the second end, that is, between the perimeter edge and the further perimeter edge.

According to an example, the outside surface of the radiator and/or the inside surface of the basket has a concave profile so as to reduce the radial width of the liner towards the first end (the perimeter edge) and the second end (the further perimeter edge) of the flange (that is to say, so that the radial width of the liner reduces towards the first and the second end of the flange).

For this reason, the concave profile defines a seat for the rolling of the ring. According to an example, the radiator, that is to say, the flange of the radiator, may be made in one piece with the concave profile, for example by injection moulding.

According to an embodiment, the ring is located in a fluid-tight fashion in the liner, so that the ring interrupts the liner dividing it into a zone proximal to the outside environment (that is to say, a first space, that is to say, a space open towards the outside environment) and in a zone distal from the outside environment (that is to say, a second space or a space isolated from the outside environment).

According to an example, the ring is located in the liner in such a way as to be compressed by a predetermined quantity relative to a rest position, along a direction transversal to the longitudinal axis.

According to the embodiment in which the width of the liner narrows towards the first and the second ends of the flange, the ring is recalled towards the zone with the larger radial width of the liner.

According to an embodiment, the stationary magnetic element and the basket define a stationary structure and the radiator and the movable magnetic element define a movable unit. The loudspeaker may comprise a guide device, configured for guiding the alternating longitudinal movement of the movable unit.

The guide device includes an inside surface, extending about a guide axis, preferably oriented longitudinally. The guide device includes an outside surface, extending about the guide axis and surrounding the inside surface to define a gap.

The guide device comprises a ring-shaped element, preferably a spring. The spring is closed on itself to form a ring. The spring is positioned in the gap in contact with the inside surface and the outside surface of the guide device, to roll on them moving, preferably longitudinally, in response to a relative movement between the inside surface and the outside surface.

The insider surface of the guide device may be connected to the stationary structure and the outside surface of the guide device may be connected to the movable unit, or vice versa.

According to an embodiment, the loudspeaker comprises an external body. The external body may be extended between a first end and a second end opposite the first end. The external body may extend longitudinally. The external body may define a support for a movable coil or for a movable magnet, that is, a movable coil or a movable magnet may be connected to the external body. According to an example, the radiator comprises a cone and the external body can be connected to the cone of the radiator. According to an example, the external body is provided in the radiator. For example, the external body may constitute a portion with a longitudinal extension of the radiator.

According to an example, the external body defines the outside surface of the guide device.

According to an embodiment, the loudspeaker comprises a further ring. The features relative to the ring according to the invention are to be considered also applicable to the further ring.

Preferably, the further ring is made of elastomeric material and is coaxial with the longitudinal axis and positioned inside the liner, in contact with the outside surface of the radiator and the inside surface of the basket so as to roll on them, moving longitudinally in response to a relative movement between the radiator and the basket. The ring and the further ring define a pair of rings. The further ring, together with the ring, has the aim of reducing the rocking phenomena.

According to an embodiment, the loudspeaker comprises an intermediate perimeter edge, provided in the radiator (in particular on the outside surface of the radiator) or in the basket (in particular on the inside surface of the basket). The intermediate perimeter edge projects towards the inside of the liner. The intermediate perimeter edge is located between the perimeter edge and the further perimeter edge. In particular, the ring is located between the perimeter edge and the intermediate perimeter edge, so as to roll between the perimeter edge and the intermediate perimeter edge. The further ring is located between the further edge and the intermediate perimeter edge, so as to roll between the intermediate perimeter edge and the further edge.

This invention also provides a method for spreading a sound.

The method comprises a step of preparing a radiator. The radiator is movable along a longitudinal axis for generating pressure waves. The radiator may be made according to one or more of the features according to the invention.

The method comprises a step of preparing a basket. The basket may be made according to one or more of the features according to the invention. The basket surrounds the radiator (about the longitudinal axis), so as to form a liner between the radiator and the basket. In particular, the liner is delimited by an inside surface of the basket and an outside surface of the radiator. The liner may be made according to one or more of the features according to the invention.

The method comprises a step of preparing a magnetic circuit. The magnetic circuit may be made according to one or more of the features according to this invention. In particular, the magnetic circuit defines a path for the circulation of a magnetic field. The magnetic circuit includes a stationary magnetic element, connected to the basket. The magnetic circuit includes a movable magnetic element, connected to the radiator.

The method comprises a step of generating a magnetic field, in response to an electrical signal to be transduced.

The method comprises a step of moving the movable magnetic element in response to the magnetic field generated, for moving the radiator along the longitudinal axis.

The method comprises a step of rolling a ring. The ring may be made according to one or more of the features according to this invention. In particular, the ring is made of deformable material, in particular plastic material, more specifically elastomeric material. The ring is coaxial with the longitudinal axis and positioned inside the liner. In particular, the ring rolls on the outside surface of the radiator and on the inside surface of the basket and moves (longitudinally) in response to a relative movement between the radiator and the basket.

According to an embodiment, the radiator comprises a flange, that is to say, the method comprises a step of preparing a flange in the radiator. The flange extends longitudinally along the longitudinal axis between a first end and a second end opposite the first end. The flange defines the outside surface of the radiator. Preferably, the flange extends parallel to the longitudinal axis. However, the flange may extend according to different orientations relative to the longitudinal axis, for example transversely to the longitudinal axis. The flange surrounds the longitudinal axis. The radiator may have a conical shape (thus, the radiator may be a cone), or cylindrical (so the radiator may be a piston).

According to an example, the method comprises a step of preparing a perimeter edge. The perimeter edge may be made according to one or more features according to the invention. The perimeter edge is positioned on a plane transversal to the longitudinal axis, preferably at the first end of the flange of the radiator. The perimeter edge projects towards the inside of the liner. The perimeter edge may be provided in the radiator and/or in the basket.

Preferably, the perimeter edge being separated from the basket by a volume of air open on the outside environment, for example at the first end of the flange (that is, at the perimeter edge).

According to an example, the method comprises a step of preparing a further perimeter edge. The further perimeter edge may be made according to one or more features according to the invention. The further perimeter edge is positioned on a further plane transversal to the longitudinal axis, preferably at the second end of the flange, or it may be positioned at a point between the first end and the second ends (for example in the mid-point). The further perimeter edge may be provided in the flange of the radiator or on the inside surface of the basket. The further perimeter edge projects towards the inside of the liner. The method may include a step of rolling the ring, preferably along the longitudinal axis, between the perimeter edge and the further perimeter edge. For this reason, the perimeter edge and the further perimeter edge constitute, respectively, a starting point and an end point for the ring.

The liner has a width, that is to say, a radial width. The width is defined in a direction radial to the longitudinal axis. The radial width is between the inside surface of the basket and the outside surface of the radiator. The radial width extends along the longitudinal axis so as to reduce towards the first end (that is, the perimeter edge) and the second end (that is, the further perimeter edge) of the flange. In other words, the (radial) width of the liner is greater at a rest point between the first and the second end of the flange (that is, between the perimeter edge and the further perimeter edge) and is less at the first end and the second end (that is, of the perimeter edge and the further perimeter edge). The method may comprise a step of recalling the ring towards a point (a rest point) between the first and the second ends, that is, between the perimeter edge and the further perimeter edge.

According to an example, the outside surface of the radiator and/or the inside surface of the basket has a concave profile so as to reduce the radial width of the liner towards the first end (the perimeter edge) and the second end (the further perimeter edge) of the flange (that is to say, so that the radial width of the liner reduces towards the first and the second end of the flange).

The method may comprise a step of compressing the ring inside the liner by a predetermined quantity relative to a rest position, along a direction transversal to the longitudinal axis. The ring is compressed by a smaller quantity in the zone with the greatest radial width of the zone and the ring is therefore recalled towards the zone with a greater radial width.

According to an embodiment, the stationary magnetic element and the basket define a stationary structure and the radiator and the movable magnetic element define a movable unit; the method may comprise a step of guiding the longitudinal movement of the movable unit by means of a guide device. The guide device may be made according to one or more of the features according to this invention. The guide device comprises an inside surface, extending about a guide axis, preferably oriented longitudinally. The guide device comprises an outside surface, extending about the guide axis and surrounding the inside surface to define a gap. The method may comprise a step of preparing a ring-shaped element, preferably a spring. The spring is closed on itself to form a ring. The spring is positioned in the gap in contact with the inside surface and the outside surface. The guide step may be performed by rolling the spring on the inside surface and the outside surface, moving, preferably longitudinally, in response to a relative movement between the inside surface and the outside surface. The inside surface may be connected to the stationary structure and the outside surface may be connected to the movable unit, or vice versa.

According to an embodiment, the method comprises a step of preparing an external body. The external body may be extended between a first end and a second end opposite the first end. The external body may extend longitudinally. The external body may define a support for a movable coil or for a movable magnet, that is, a movable coil or a movable magnet may be connected to the external body. According to an example, the radiator comprises a cone and the external body can be connected to the cone of the radiator. According to an example, the external body is provided in the radiator. For example, the external body may constitute a portion with a longitudinal extension of the radiator. According to an example, the external body defines the outside surface of the guide device.

According to an embodiment, the method comprises a step of rolling a further ring. The features relative to the ring according to the invention are to be considered also applicable to the further ring.

Preferably, the further ring is made of plastic material and is coaxial with the longitudinal axis and positioned inside the liner, on the outside surface of the radiator and the inside surface of the basket, moving longitudinally in response to a relative movement between the radiator and the basket. The ring and the further ring define a pair of rings.

According to an embodiment, the method comprises a step of preparing an intermediate perimeter edge, provided in the radiator (in particular on the outside surface of the radiator) or in the basket (in particular on the inside surface of the basket). The intermediate perimeter edge projects towards the inside of the liner. The intermediate perimeter edge is located between the perimeter edge and the further perimeter edge. In particular, the ring is located between the perimeter edge and the intermediate perimeter edge, so as to roll between the perimeter edge and the intermediate perimeter edge. The further ring is located between the further edge and the intermediate perimeter edge, so as to roll between the intermediate perimeter edge and the further edge.

These and other features of the invention will become more apparent from the following detailed description of a preferred, non-limiting example embodiment of it, with reference to the accompanying drawings, in which:

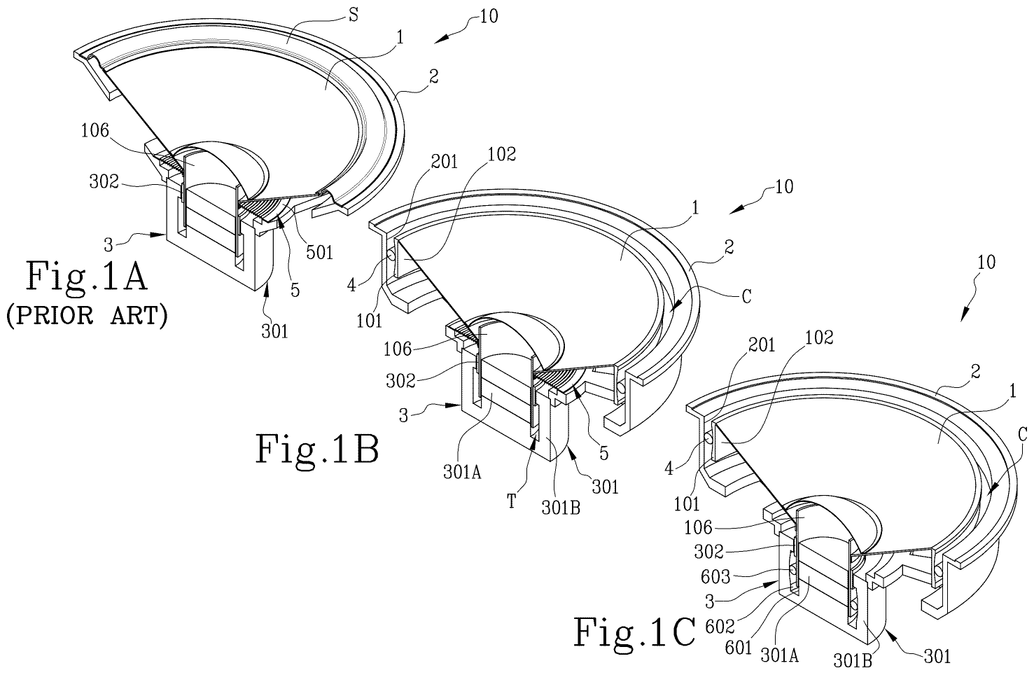

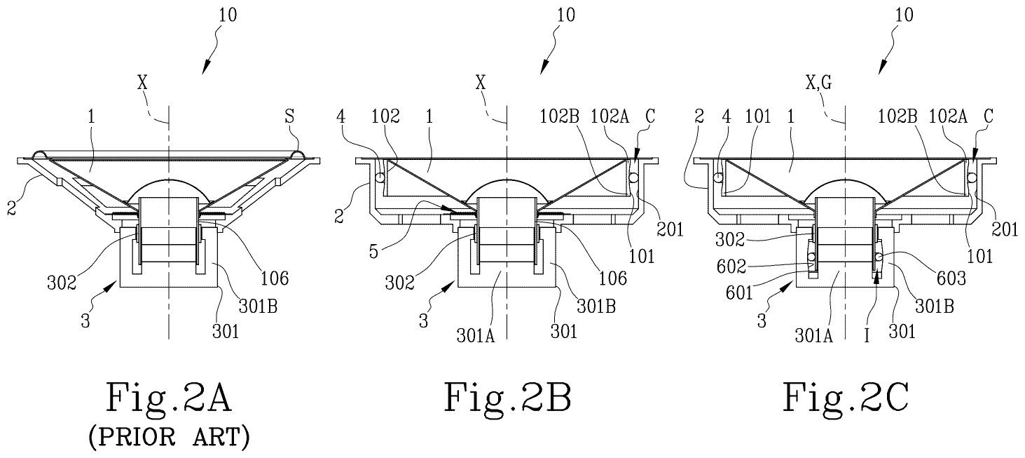

FIGS. 1A and 2A illustrate a loudspeaker according to the prior art;

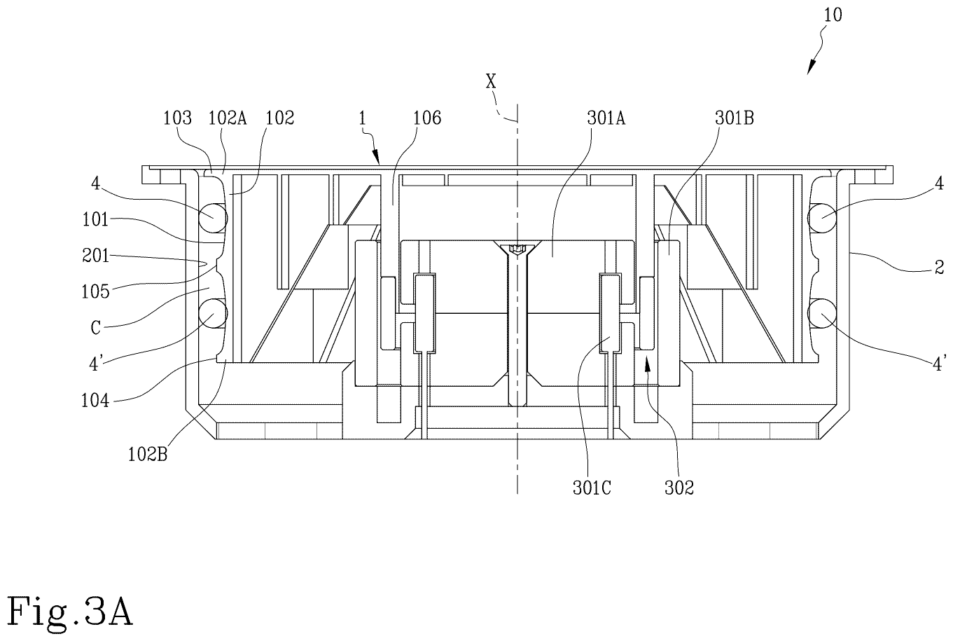

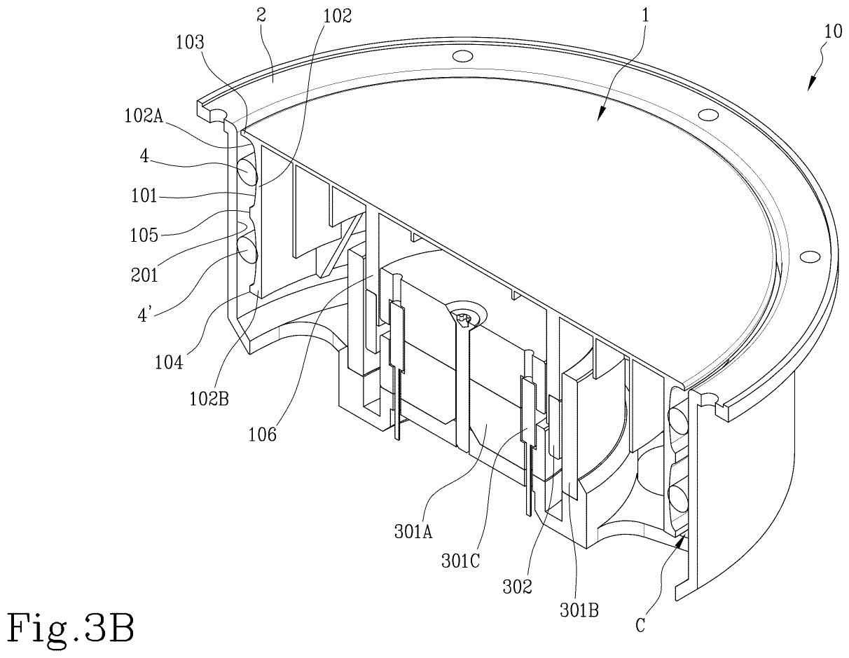

FIGS. 1B, 1C, 2B, 2C, 3A and 3B illustrate cross sections of a loudspeaker according to one or more aspects of this invention;

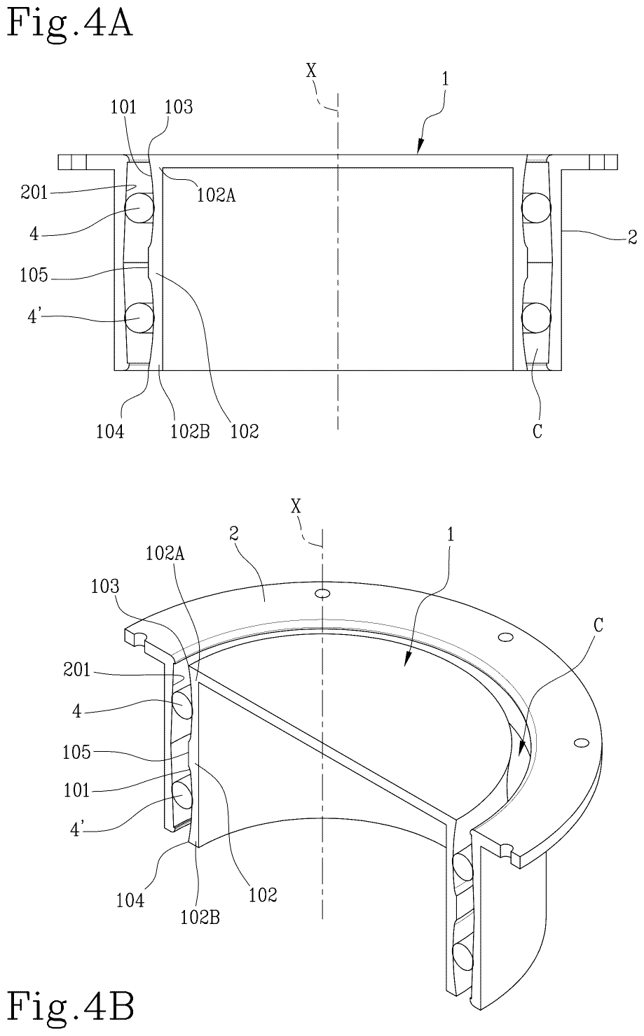

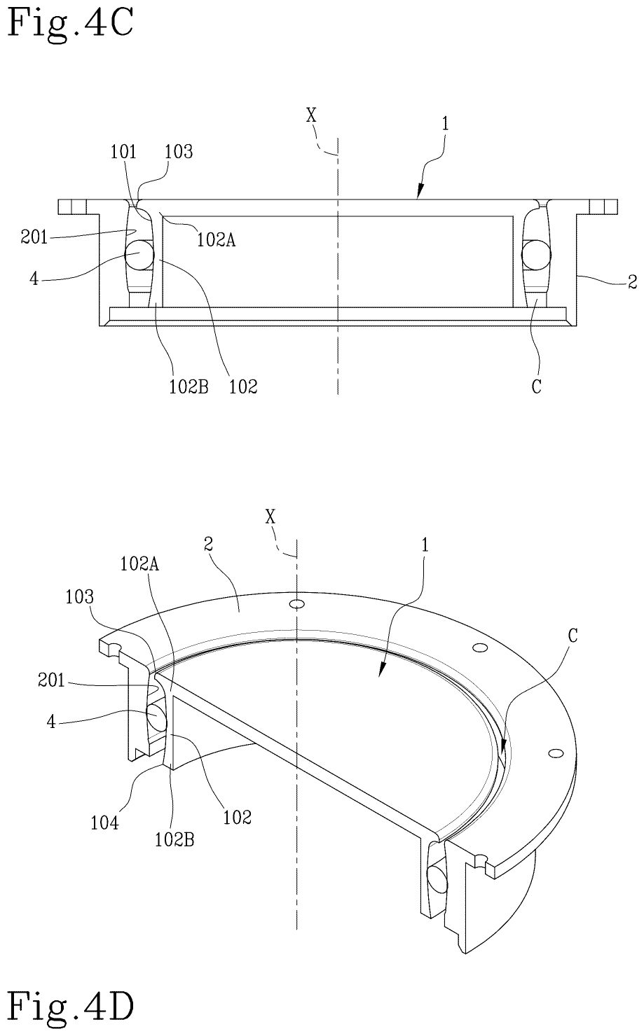

FIGS. 4A-4D illustrate cross sections of a radiator and a basket of a loudspeaker according to one or more aspects of this invention;

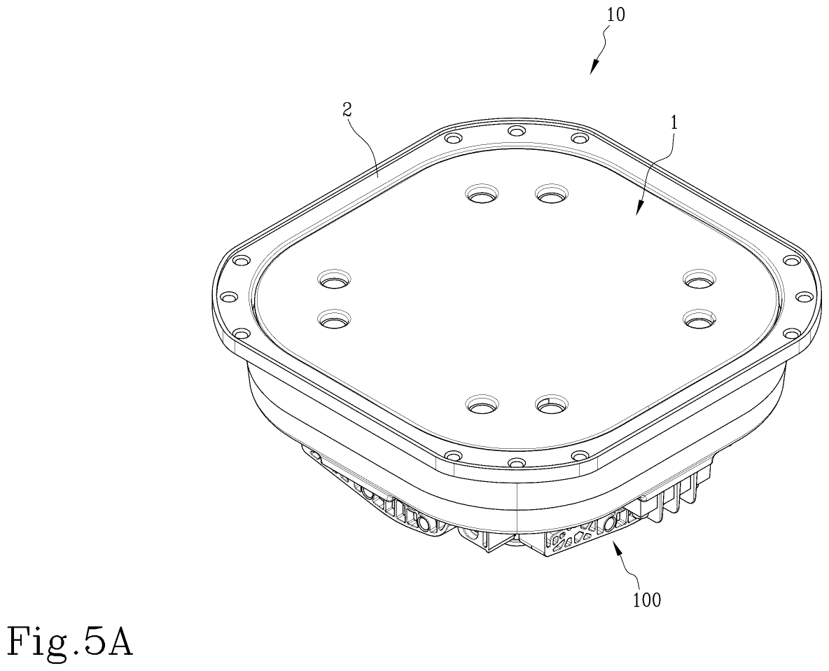

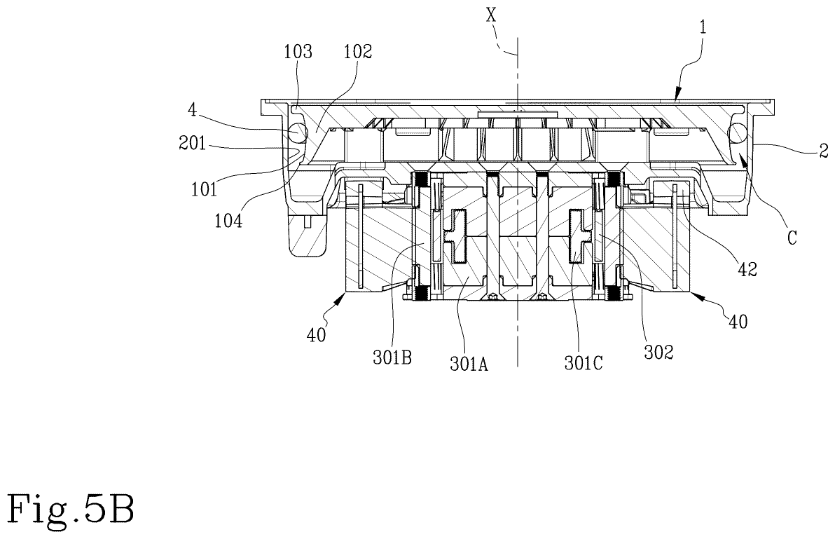

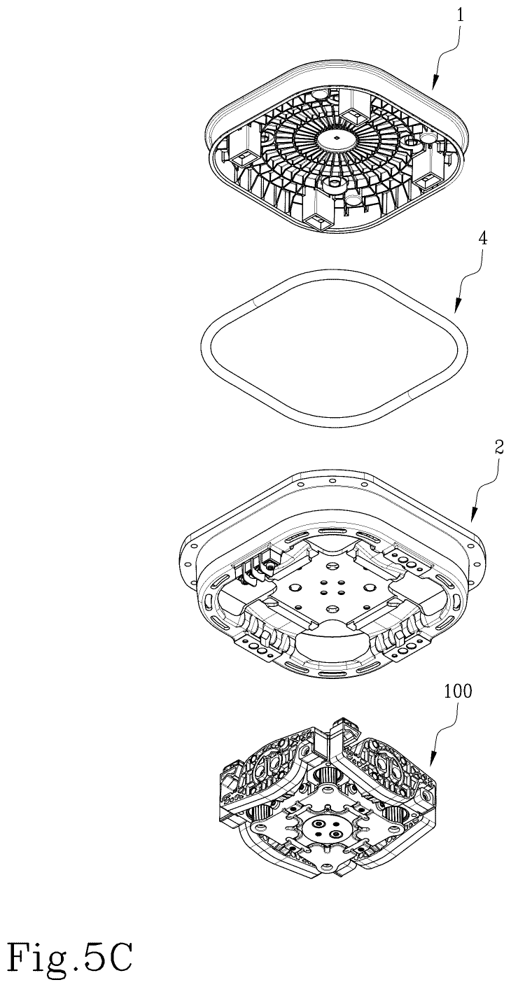

FIGS. 5A-5C illustrate a loudspeaker according to one or more aspects of this invention;

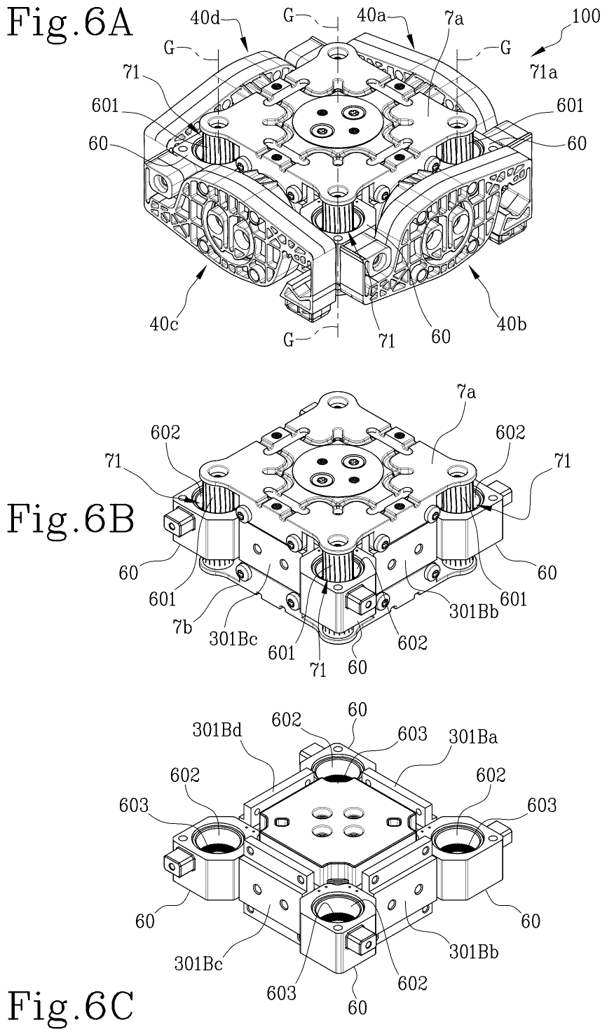

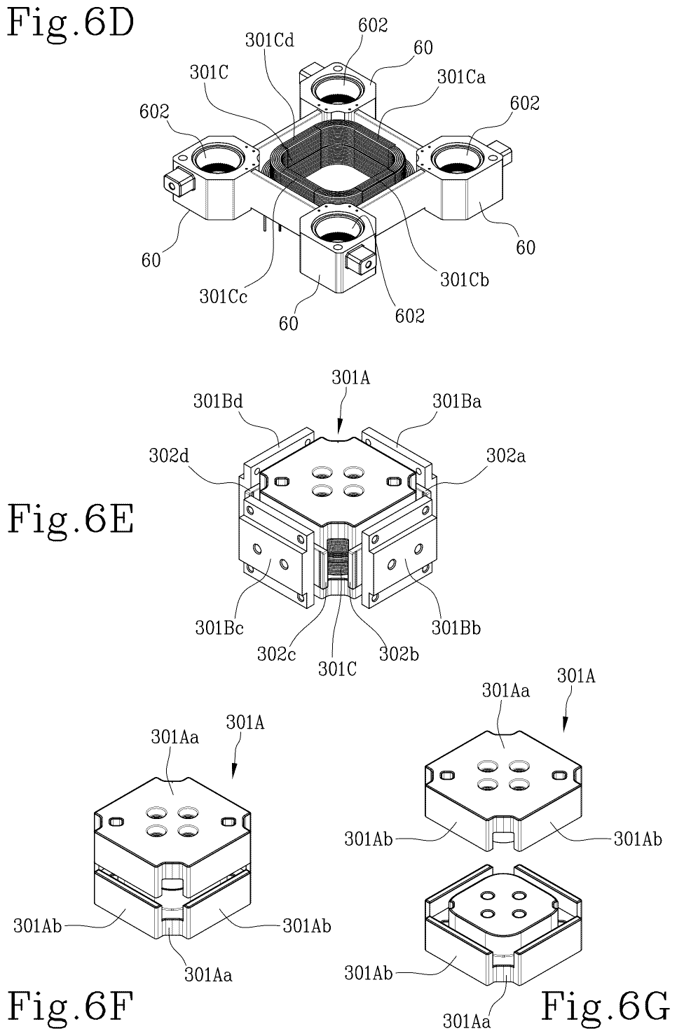

FIGS. 6A-6G illustrate a transducer of a loudspeaker according to one or more aspects of the invention.

The numeral 10 in the accompanying drawings denotes a loudspeaker. The loudspeaker 10 comprises a radiator 1. The radiator 1 is movable along a longitudinal axis X, so as to generate pressure waves. The loudspeaker 10 comprises a basket 2. The loudspeaker 10 comprises a magnetic circuit 3, configured to generate a magnetic field and defining a path for the circulation of a magnetic field.

The magnetic circuit 3 includes a stationary magnetic element 301, connected to the basket 2. The magnetic circuit 3 includes a movable magnetic element 302, connected to the radiator 2 and movable under the action of the magnetic field to move the radiator 2 in response to an electrical signal to be transduced. The movable magnetic element 302 may include one or more magnets, or a coil.

The stationary magnetic element 301 may include a coil. The coil comprises a plurality of coils wound around a winding axis; preferably, the winding axis coincides with the longitudinal axis X. The coil is configured to generate a magnetic field when the electrical signal to be transduced passes through it. The magnetic circuit 3 defines a transducer for the loudspeaker 10. The stationary magnetic element 301 includes a central core 301A and an outer core 301B. The central core 301A extends along the longitudinal axis X between a first end, proximal to the radiator 1 and a second end, opposite the first end. The outer core 301B is located outside the central core 301A so as to define an air gap T in which the movable coil or the movable magnet (that is, the one or more movable magnets) is movable longitudinally. The outer core 301B is connected, directly or indirectly, to the inner core 301A, preferably at the second end of the inner core 301A. The inner core 301A and the outer core 301B are configured to allow a circulation of a magnetic field inside the ferromagnetic circuit 3.

The magnetic field generated (by the coil) interacts with the inner core 301A and the outer core 301B (that is, it circulates inside the inner core 301A and the outer core 301B). The coil (in the case of the movable coil) or the one or more magnets (in the case of the movable magnet) interacts with the magnetic field so as to move longitudinally inside the air gap T.

The basket 2 surrounds the radiator 1 about the longitudinal axis X, so as to form a liner C between the radiator 1 and the basket 2. In particular, the liner C is delimited by an inside surface 201 of the basket 2 (that is to say, an inside surface 201 facing towards the longitudinal axis X) and by an outside surface 101 of the radiator 1 (that is to say, an outside surface 101 facing in the opposite direction relative to the longitudinal axis X). The liner C extends parallel to the longitudinal axis X.

In particular, the radiator 1 comprises a flange 102, extending along the longitudinal axis X between a first end 102A and a second end 102B opposite the first end 102A and defining the outside surface 101 of the radiator 1.

The loudspeaker 10 comprises a ring 4 made of elastomeric material. The ring 4 is coaxial with the longitudinal axis X and positioned inside the liner C, in contact with the outside surface 101 of the radiator 1 and the inside surface 201 of the basket 2, so as to roll on them, in response to a relative movement between the radiator 1 and the basket 1.

The radiator 1 comprises a perimeter edge 103, positioned on a plane transversal to the longitudinal axis X, at the first end 102A of the flange 102. The perimeter edge 103 projects towards the inside of the liner C. For example, the perimeter edge 103 is connected to an outline of the radiator 1. At the first end 102A of the flange 102, the radiator 1 and the basket 2 are separated from each other by a volume of air open to the outside environment.

The radiator 1 comprises a further perimeter edge 104, positioned on a further plane transversal to the longitudinal axis X. The plane and the further plane are parallel to each other. The further perimeter edge 104 is located at the second end 102B of the flange 102. The further perimeter edge 103 projects towards the inside of the liner C.

The ring 4 is configured to roll inside the liner C between the perimeter edge 103 and the further perimeter edge 104. For this reason, the perimeter edge 103 and the further perimeter edge 104 define, respectively, a starting point and an end point for the ring 4.

The liner C has a radial width between the inside surface 201 of the basket 2 and the outside surface 101 of the radiator 1 extending along the longitudinal axis X so as to reduce towards the perimeter edge 103 and the further perimeter edge 104. The liner C has a maximum radial width at a point between the perimeter edge 103 and the further perimeter edge 104; the point included defines a point of equilibrium at which the ring 4 is recalled.

According to an example, the outside surface 101 of the radiator 1 and/or the inside surface 201 of the basket has a concave profile so as to reduce the radial width of the liner C towards the perimeter edge 103 and towards the further perimeter edge 104.

The ring 4 is located in a fluid-tight fashion in the liner C, so that the ring 4 interrupts the liner C dividing it into a zone proximal to the outside environment and in a zone distal to the outside environment. Moreover, the ring 4 is located inside the liner C so as to be compressed by a predetermined quantity relative to a rest position along a direction transversal to the longitudinal axis X. For this reason, when moving between the perimeter edge 103 and the further perimeter edge 104, the ring 4 is subjected to a return force which causes it to be positioned in the position in which the liner C has the greatest radial width.

The loudspeaker 10 may comprise a further ring 4′ made of elastomeric material. The further ring 4′ is coaxial with the longitudinal axis X and positioned inside the liner C, in contact with the outside surface 101 of the radiator 1 and the inside surface 201 of the basket 2 so as to roll on them, moving longitudinally in response to a relative movement between the radiator 1 and the basket 2. For this reason, the ring 4 and the further ring 4′ move together and define a pair of rings. The radiator 1 may comprise an intermediate perimeter edge 105, positioned on an intermediate plane transversal to the longitudinal axis X. The intermediate plane is parallel to the plane and to the further plane. The intermediate perimeter edge 104 is located between the perimeter edge 103 and the further perimeter edge 104. In this case, the ring 4 is located between the perimeter edge 103 and the intermediate perimeter edge 104 and the further ring 4′ is located between the intermediate perimeter edge 105 and the further perimeter edge 104. The ring 4 rolls between the perimeter edge 103 and the intermediate perimeter edge 105, whilst the ring 4′ rolls between the intermediate perimeter edge 105 and the further perimeter edge 104.

According to an example, the liner C has a radial width between the inside surface 201 of the basket 2 and the outside surface 101 of the radiator 1 extending along the longitudinal axis X so as to reduce towards the perimeter edge 103, the intermediate perimeter edge 105 and the further perimeter edge 104. The liner C has a maximum radial width at a first point between the perimeter edge 103 and the intermediate perimeter edge 105 and at a second point between the intermediate perimeter edge 105 and the further perimeter edge 104; the first point defines an equilibrium point where the ring 4 is recalled and the second point defines a equilibrium point where the further ring 4′ is recalled.

According to an example, the outside surface 101 of the radiator 1 and/or the inside surface 201 of the basket has a concave profile so as to reduce the radial width of the liner C towards the perimeter edge 103, towards the further perimeter edge 104 and towards the intermediate perimeter edge 105.

The further ring 4 is also positioned in a fluid-tight fashion in the liner C. In this way, the ring 4 and the further ring 4′ interrupt the liner C dividing it in a zone proximal to the outside environment, in a zone distal to the outside environment and an intermediate zone between the proximal zone and the distal zone. The further ring 4′ may also be located inside the liner C so as to be compressed by a predetermined quantity relative to a rest position along a direction transversal to the longitudinal axis X. For this reason, when moving between the intermediate perimeter edge 105 and the further perimeter edge 104, the further ring 4′ is subjected to a return force which causes it to be positioned in the position in which the liner C has the greatest radial width (that is to say, the second point).

According to an embodiment, the loudspeaker 10 comprises an external body 106, extending between a first end and a second end opposite the first end. The external body 106 extends longitudinally. The external body 106 may define a support for a movable coil or for a movable magnet, that is, a movable coil or a movable magnet may be connected to the external body 106. According to an example, the radiator 1 comprises a cone and the external body 106 can be connected to the cone of the radiator. According to an example, the external body 106 is provided in the radiator 1. For example, the external body 106 may constitute a portion with a longitudinal extension of the radiator 1. The external body 106 may be partly inserted inside an air space T.

The loudspeaker 10 may comprise a spider 5, located between the longitudinal portion 106, that is, the external body, and the basket. The spider 5 is configured for centring the radiator 1 and the basket 2 along the longitudinal axis X.

According to an embodiment, the stationary magnetic element 301 (that is, the inner core 301A, the outer core 301B, and, if stationary, a coil 301B) together with the basket 2 define a stationary structure. According to an example, the movable magnetic element 302 (that is, the movable coil or the movable magnet) together with the radiator 1 define a movable unit. The movable unit moves with reciprocating motion along the longitudinal axis X. The loudspeaker 10 may comprise a guide device, configured for guiding the alternating longitudinal movement of the movable unit. The guide device includes an inside surface 601, extending about a guide axis G oriented longitudinally. The guide device includes an outside surface 602, extending around the guide axis G and surrounding the inside surface 601 to define a gap I. The guide device comprises a spring 603, closed on itself to form a ring and positioned in the gap I in contact with the inside surface 601 and the outside surface 602 of the guide device, to roll on them while moving longitudinally in response to a relative movement between the inside surface 601 and the outside surface 302.

The inside surface 601 of the guide device may be connected to the stationary structure and the outside surface 602 of the guide device may be connected to the movable unit, or vice versa. Preferably, the inside surface 601 of the guide device is connected to the stationary structure and the outside surface 602 is connected to the movable unit.

According to an embodiment, the external body 106 may define the outside surface 602 of the guide device. The outer core 301B of the magnetic circuit 3 may define the inside surface 601 of the guide device. The external body 106 may form part of the movable unit.

According to an example embodiment, illustrated purely by way of example in FIGS. 6A-6G, the fixed coil 301C comprises a plurality of rectilinear portions, in particular, a first rectilinear portion 301Ca, a second rectilinear portion 301Cb, a third rectilinear portion 301Cc and a fourth rectilinear portion 301Cd. The first 301Ca, the second 301Cb, the third 301Cc and the fourth 301Cd rectilinear portions are joined together by curvilinear connecting stretches. The straight portions face each other in pairs. The rectilinear portions lie on a same plane transversal to the longitudinal axis X and are positioned symmetrically relative to the longitudinal axis X. According to the examples illustrated, the rectilinear portions define a square in a plane transversal to the longitudinal axis X.

The outer core 301B of the ferromagnetic circuit 301 may comprise a plurality of portions, in particular a first portion 301Ba, a second portion 301Bb, a third portion 301Bc and a fourth portion 301Bd. The portions of the plurality of portions of the outer core 301B may be separated from each other. The plurality of portions of the outer core 301B is located laterally to the plurality of rectilinear portions of the fixed coil 301C, so as to define a plurality of gaps T.

The transducer 100 may comprise a plurality of magnets, in particular a first magnet 302a, a second magnet 302b, a third magnet 302c and a fourth magnet 302d. Each magnet of the plurality of magnets is located in a corresponding gap T of the plurality of gaps T defined by the plurality of rectilinear portions of the coil 301C and by the plurality of portions of the outer core 301B. Each magnet of the plurality is movable in an air gap T along respective directions of movement parallel to the longitudinal axis X. Therefore, when the coil 301B is energised to generate the magnetic energising field, a movement of the plurality of magnets is induced along the respective directions of movement. The movement of the magnets causes an oscillation of the radiator 1 to which the transducer 100 is connected. The magnets are joined to each other by respective angular elements 60, located at the curvilinear connecting stretches of the coil 301C, so as to form a rigid structure movable along the longitudinal direction X. In particular, the rigid structure does not allow a movement along a direction transversal to the longitudinal axis X (that is, along any direction transversal to the longitudinal axis X), whilst it allows the movement along the longitudinal direction X.

Each magnet has an extension transversal to the longitudinal axis X between a first end and a second end; at the ends, each magnet has a south pole and a north pole.

The acoustic transducer 100 comprises four guide devices, each of which is coupled to an angular element 60. Each guide device comprises an outside surface 602, defined by the angular element 60. The angular element 60 defines an external body for the amplifier 10. The outside surface 602 extends about a guide axis G, parallel to the longitudinal axis X.

The transducer 100 comprises an upper half-shell 7a and a lower half-shell 7b. Each guide device comprises an inside surface 601. The insider surface 601 is defined by the upper half-shell 7a. In particular, the upper half-shell 7a comprises four longitudinal portions 71, inserted inside the angular elements 60 and defining the inside surfaces 601 for the guide devices. Therefore, the inside surfaces 601 extend about the guide axis G. The outside surface 602 surrounds the inside surface 601 in such a way as to define a gap I. Each guide device comprises an elastic element 603, preferably a spring, closed on itself to form a ring positioned in the gap I in contact with the inside surface 601 and the outside surface 602, to roll on them while moving longitudinally in response to a relative movement between the inside surface 601 and the outside surface 602. The upper half-shell 7a is connected in an integral fashion to the inner core 301A of the ferromagnetic circuit 3; therefore, the inside surface 601 is connected, through the upper half-shell 7a, to the inner core 301A. The angular element 60 is connected in an integral fashion to a pair of magnets of the plurality of magnets; for this reason, the outside surface 602 is connected through the angular element 60 to the pair of magnets to which the angular element 60 is connected. In this way, when the magnets move along the respective directions of movement, the outside surface 602 moves as one with the magnets and slides relative to the inside surface 601 which remains stationary, and the elastic element 603 rolls between the outside surface 602 and the inside surface 601.

According to an example, the inner core 301A comprises a central portion 301Aa and a lateral portion 301Ab. The outside lateral portion 301Ab is separated from the outer core 301B by the plurality of gaps T. The lateral portion 301Ab has a high magnetic permeability zone close to the coil 301C. The high magnetic permeability zone is defined by a notch transversal to the longitudinal axis X, such as to divide the central core 301A into an upper portion and a lower portion, juxtaposed with the longitudinal axis X. According to an example, in the lower portion of the central core 301A, the central portion 301Aa and the lateral portion 301Ab define a seat for the coil 301C.

The lateral portions 301Ab of the upper portion and of the lower portion act in conjunction to form the notch area. The notch may surround the entire perimeter of the coil 301C, except at the points at the curvilinear connecting stretches.

The rectilinear portions of the coil 301C are placed alongside the central portion 301Aa of the core 301A and the lateral portions 301Ab of the core 301A.

The transducer 100 comprises a lower half-shell 7b. The upper half-shell 7a and the lower half-shell 7b are juxtaposed with each other along the longitudinal axis X and are configured to retain the plurality of portions 301Ba, 301Bb, 301Bc and 301Bd of the outer core 301B.

The transducer 100 may comprise a mechanical transmission system. The mechanical transmission may comprise a plurality of actuating elements 40 (that is, a first, a second, a third and a fourth actuating element 40a, 40b, 40c, 40d), interposed between a corresponding magnet of the plurality of magnets 302a, 302b, 302c, 302d and the radiator 1 for moving it, in the same direction or in the opposite direction to the magnets; in this way, a movement of the magnets along the respective direction of movement in one direction corresponds to a movement of the radiator 1 along the longitudinal axis X in a same direction or in an opposite direction.

According to an aspect of the invention, each actuating element 40 of the plurality comprises a single rotary element 41; each single rotary element 41 is pivoted at a connection point on a corresponding portion of the plurality of portions which are part of the plurality of parts 301Ba, 301Bb, 301Bc and 301Bd of the outer core 301B. Each actuating element 40 is connected laterally to an angular element 60, so that when the angular element 60 moves longitudinally, the actuating element (in particular the rotary element) rotates and transmits the mode to the radiator 1, through a connecting body 42.

1. A loudspeaker, comprising:
a radiator, movable along a longitudinal axis to generate pressure waves;
a basket, surrounding the radiator so as to form a liner included between the radiator and the basket, the liner being delimited by an inside surface of the basket and an outside surface of the radiator;
a magnetic circuit, defining a path for the circulation of a magnetic field and including a stationary magnetic element, connected to the basket, and a movable magnetic element, connected to the radiator and movable under the action of the magnetic field to move the radiator responsive to an electrical signal to be transduced;
a ring of elastomeric material, coaxial with the longitudinal axis and disposed inside the liner, in contact with the outside surface of the radiator and the inside surface of the basket so as to roll on them, moving longitudinally responsive to a relative movement between the radiator and the basket.

2. The loudspeaker according to claim 1, wherein the radiator comprises a flange running parallel to the longitudinal axis, extending between a first end and a second end, opposite the first end, and defining the outside surface of the radiator.

3. The loudspeaker according to claim 2, wherein the radiator comprises a perimeter edge, positioned in a plane transverse to the longitudinal axis, jutting from the flange towards the inside of the liner, at the first end of the flange, the perimeter edge being separated from the basket by an air space which is open to the outside environment.

4. The loudspeaker according to claim 3, wherein the radiator comprises a further perimeter edge, positioned in a further plane which is transverse to the longitudinal axis at the second end of the flange, jutting towards the inside of the liner, the further perimeter edge being provided on the flange or on the inside surface of the basket, the ring being configured to roll along the longitudinal axis between the perimeter edge and the further perimeter edge.

5. The loudspeaker according to claim 4, wherein the liner has a width which is radial to the longitudinal axis, the radial width of the liner extending longitudinally so as to be reduced towards the first end and second end of the flange.

6. The loudspeaker according to claim 5, wherein the outside surface of the radiator and the inside surface of the basket each have a concave profile so as to reduce the radial width of the liner towards the first end and second end of the flange.

7. The loudspeaker according to claim 1, wherein the ring is located inside the liner fluid-sealedly so that the ring interrupts the liner dividing it into a zone proximal to the outside environment and a zone distal to the outside environment.

8. The loudspeaker according to claim 1, wherein the ring is located inside the liner so as to be compressed by a predetermined quantity relative to a rest position, along a direction transverse to the longitudinal axis.

9. The loudspeaker according to claim 1, wherein the stationary magnetic element and the basket define a stationary structure, and the radiator and the movable magnetic element define a movable working unit, the loudspeaker comprising:
a guiding device, configured to guide the longitudinal reciprocating movement of the movable working unit and including an inside surface, extending around a guide axis oriented longitudinally, and an outside surface, extending around the guide axis and surrounding the inside surface to define a gap;
a spring, closed on itself to form a ring, disposed in the gap in contact with the inside surface and with the outside surface to roll on them while moving longitudinally responsive to a relative movement between the inside surface and the outside surface,
wherein the inside surface is connected to the stationary structure and the outside surface is connected to the movable working unit, or vice versa.

10. The loudspeaker according to claim 9, comprising an external body, extended between a first end and a second end opposite the first end, extending longitudinally and defining the outside surface of the guiding device.

11. The loudspeaker according to claim 1, comprising a further ring of elastomeric material, coaxial with the longitudinal axis and disposed inside the liner, in contact with the outside surface of the radiator and the inside surface of the basket so as to roll on them, moving longitudinally responsive to a relative movement between the radiator and the basket, the ring and the further ring defining a pair of rings.

12. A method for spreading a sound, comprising the following steps:
providing a radiator along a longitudinal axis, and a basket, surrounding the radiator so as to form a liner included between the radiator and the basket, the liner being delimited by an inside surface of the basket and an outside surface of the radiator;
providing a magnetic circuit, defining a path for the circulation of a magnetic field and including a stationary magnetic element, connected to the basket, and a movable magnetic element, connected to the radiator;
generating a magnetic field responsive to an electrical signal to be transduced;
moving the movable magnetic element responsive to the magnetic field generated, so as to move the radiator along the longitudinal axis;
rolling a ring of plastic material, coaxial with the longitudinal axis and disposed inside the liner, on the outside surface of the radiator and on the inside surface of the basket, moving longitudinally responsive to a relative movement between the radiator and the basket (2).

13. The method according to claim 12, wherein:
a flange running parallel to the longitudinal axis, extending between a first end and a second end, opposite the first end, and defining the outside surface of the radiator;
a perimeter edge, positioned in a plane transverse to the longitudinal axis, jutting from the flange towards the inside of the liner, at the first end of the flange, the perimeter edge being separated from the basket by an air space which is open to the outside environment.

14. The method according to claim 13, wherein the radiator comprises a further perimeter edge, positioned in a further plane which is transverse to the longitudinal axis at the second end of the flange, jutting towards the inside of the liner, the further perimeter edge being provided on the flange or on the inside surface of the basket, the ring rolling along the longitudinal axis between the perimeter edge and the further perimeter edge.

15. The method according to claim 12, wherein the stationary magnetic element and the basket define a stationary structure, and the radiator and the movable magnetic element define a movable working unit, the method comprising the following steps:
guiding the longitudinal movement of the movable working unit via a guiding device, comprising an inside surface, extending around a guide axis oriented longitudinally, and an outside surface, extending around the guide axis and surrounding the inside surface to define a gap;
providing a spring, closed on itself to form a ring, disposed in the gap in contact with the inside surface and with the outside surface of the guiding device,
wherein the step of guiding occurs by rolling the spring on the inside surface and outside surface of the guiding device, moving longitudinally responsive to a relative movement between the inside surface and the outside surface, wherein the inside surface is connected to the stationary structure and the outside surface is connected to the movable working unit, or vice versa.

16. The method according to claim 12, comprising a step of rolling a further ring of elastomeric material, coaxial with the longitudinal axis and disposed inside the liner, on the outside surface of the radiator and on the inside surface of the basket, moving longitudinally responsive to a relative movement between the radiator and the basket, the ring and the further ring defining a pair of rings.

17. A loudspeaker, comprising:
a radiator, movable along a longitudinal axis to generate pressure waves;
a basket, surrounding the radiator so as to form a liner included between the radiator and the basket, the liner being delimited by an inside surface of the basket and an outside surface of the radiator;
a magnetic circuit, defining a path for the circulation of a magnetic field and including a stationary magnetic element, connected to the basket, and a movable magnetic element, connected to the radiator and movable under the action of the magnetic field to move the radiator responsive to an electrical signal to be transduced;
a ring of elastomeric material, coaxial with the longitudinal axis and disposed inside the liner, in contact with the outside surface of the radiator and the inside surface of the basket so as to roll on them, moving longitudinally responsive to a relative movement between the radiator and the basket;
a perimeter edge, provided in the radiator and/or in the basket and positioned on a plane transversal to the longitudinal axis and projecting towards the inside of the liner, wherein, at the the perimeter edge, the radiator and the basket are separated from each other by a volume of air open on the outside environment.

18. The loudspeaker of claim 17, wherein the liner is open to an external environment through an upper opening and is open to the environment outside the speaker at the perimeter edge, and wherein the loudspeaker comprises a jacket open to an environment inside the speaker via a lower opening.

19. The loudspeaker of claim 17, wherein the radiator comprises a flange running parallel to the longitudinal axis, extending between a first end and a second end, opposite the first end, and defining the outside surface of the radiator, and wherein the flange is connected to the perimeter edge of the radiator.

20. The loudspeaker of claim 19, wherein the first end of the flange is proximal to the environment outside the loudspeaker and the second end of the flange is distal to the environment outside the loudspeaker, and wherein, at the first end, the flange is in communication with the environment outside the speaker, the first of the flange defining least partially an upper opening of the liner.
